(19) United States
(12) Patent Application Publication
(10) Pub. No.: US 2004/0003034 A1
(43) Pub. Date: Jan. 1, 2004

(54) Method for notification of varying versions of code between client and server

(76) Inventors: Weiyun Sun, Rocklin, CA (US); Rajeev Grover, Rocklin, CA (US); John Nolan, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/185,919

(22) Filed: Jun. 27, 2002

(51) Int. Cl. G06F 15/16

(52) U.S. Cl. 709/203; 709/218

(57) ABSTRACT

A method for notification of varying versions of code between a server computer and a client computer is disclosed. A version of the code is received by the client from the server. That version is compared with the code version cached at the client. In response to determining that that version of code differs from the code version cached at the client, an action is taken.

### FIELD OF THE INVENTION

Embodiments of the present invention relate to the field of network computing in a client-server environment. Specifically, embodiments of the present invention relate to a method for notification of varying versions of code between a server computer and a client computer.

### BACKGROUND OF THE INVENTION

Modern network computing allows great benefits by sharing information and computing resources. As an example, information is transmitted within networks between server computers and client computers in response to requests by the client computer's browser. The information returned by the server to the client is used for various applications run on the client computer.

In one conventional approach, smaller applications running on the client computer, such as utility programs and limited function word processors and spread sheets, comprise applets. Often, applets are Java programs, and Java programs that are run from a browser are generally applets. Transfer of information to a client computer for applets and other applications requires time and use of network resources.

Java applet code and other such code is often stored on the server computer and downloaded to a client computer for execution thereon. Most Java applet code and other such code is retrieved by the client computer's web browser using a HyperText Transfer Protocol (HTTP) upon requesting a Uniform Resource Locator (URL) from the server.

To avoid unnecessary download time and network traffic, the browser running on a client computer often caches the code of Java applets and other applications. When the browser makes subsequent requests to the server, the Java applet or other code stored in the client computer's cache does not need to be downloaded again.

However, a problem may arise in the event of the Java applet code on the server being updated. In such an event, the client computer may not be informed that an updated version of the Java applet or other code exists on the server and that the corresponding version of the code cached on the client computer may be out of date.

Without being informed of the updated Java applet code or other code version on the server, the client computer may attempt to run the applet or other application with the out of date version cached thereon. This can lead to sub-optimal performance or failure of the Java applet or other application to utilize the information returned to it by the server.

Conventionally, in order to ensure that it is running the most up-to-date version of the Java applet code or other code version, a user of the client computer explicitly does not to cache any code in the client computer's browser. This conventional approach of “selecting not to cache” any code in the browser of the client computer may be problematic for several reasons.

Selecting not to cache any code in the browser of the client computer compromises download speed because each and every time the browser requests information from a server on behalf of an application, the corresponding Java applet code or other code must be transmitted by the server. This also negatively impacts network traffic because additional data must be transferred.

Further, in the event that a user forgets to clear the cached code and inadvertently uses the out-of-date Java applet code cached on the browser, a problem can arise with sub-optimal performance or failure. Yet under those circumstances, the user may not be able to readily ascertain what has gone wrong.

A user under such circumstances must either bear with the problem or commit to troubleshooting. This can be inefficient, costly in terms or productivity, wasteful of resources, and expensive.

### SUMMARY OF THE INVENTION

A method for notification of varying versions of code between a server computer and a client computer is disclosed. In one embodiment, a version of the code is received by the client from the server. That version is compared with the code version cached at the client. In response to determining that that version of code differs from the code version cached at the client, an action is taken.

### BRIEF DESCRIPTION OF THE DRAWINGS

FIG. 1 is a block diagram of a system for notification of varying versions of code between a server computer and a client computer according to one embodiment of the present invention.

FIG. 2 is a flowchart of the steps in a process for notification of varying versions of code between a server computer and a client computer according to one embodiment of the present invention.

FIG. 3 is a flowchart of the steps in a process for notification of varying versions of Java applet code between a server computer and a client computer according to one embodiment of the present invention.

### DETAILED DESCRIPTION OF THE INVENTION

Embodiments of the present invention effectuate a method and system for notification of varying versions of code between a server computer and a client computer.

### NOTATION AND NOMENCLATURE

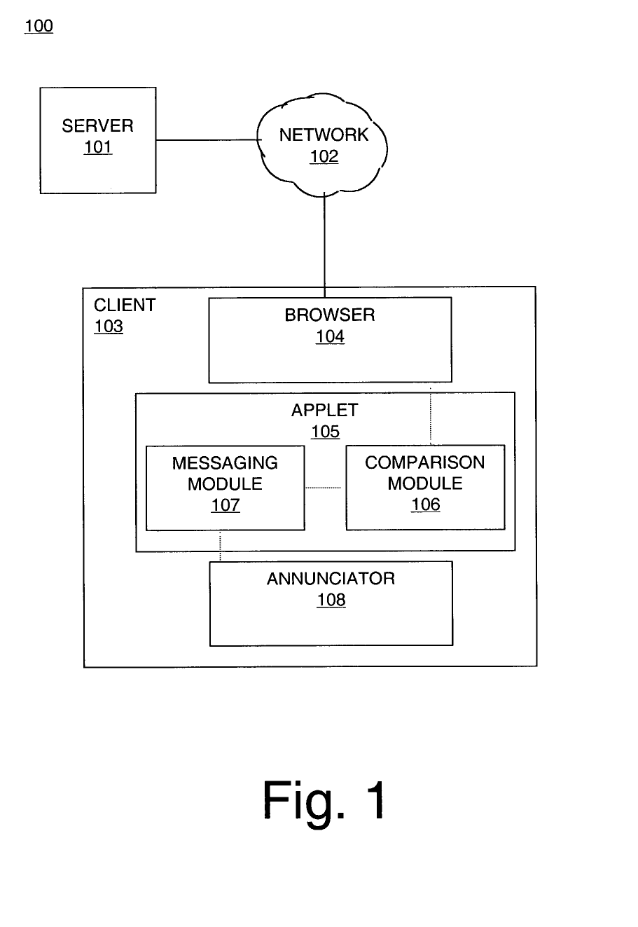

One embodiment of the present invention is deployed within a network environment (e.g., network environment 100; FIG. 1) comprising a server, a network, and a client computer (e.g., server 101, network 102, client computer 103; FIG. 1). The network of this environment can be any kind of network, such as a local area network (LAN), wide area network (WAN), or the Internet.

A computer system that embodies the system for notification of varying versions of code between a server computer and a client computer can be any kind of computer system. For example, the computer system can be a workstation computer system, a personal computer system, a main-frame computer system, or a supercomputer system. In one embodiment, the computer system is a client computer system (e.g., client computer 103; FIG. 1). Modules of the system for notification of varying versions of code between a server computer and a client computer can be deployed in software, firmware, and/or hardware or any combination of software, firmware, and/or hardware.

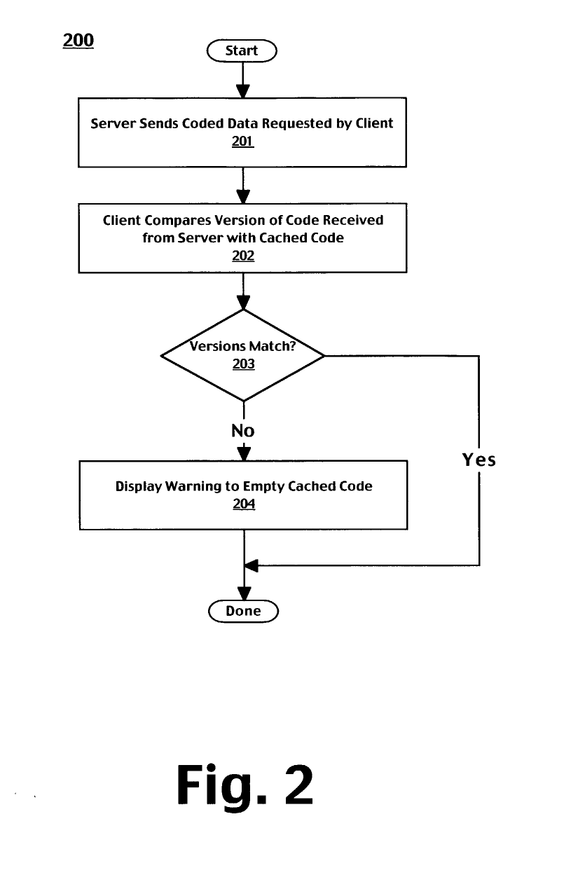

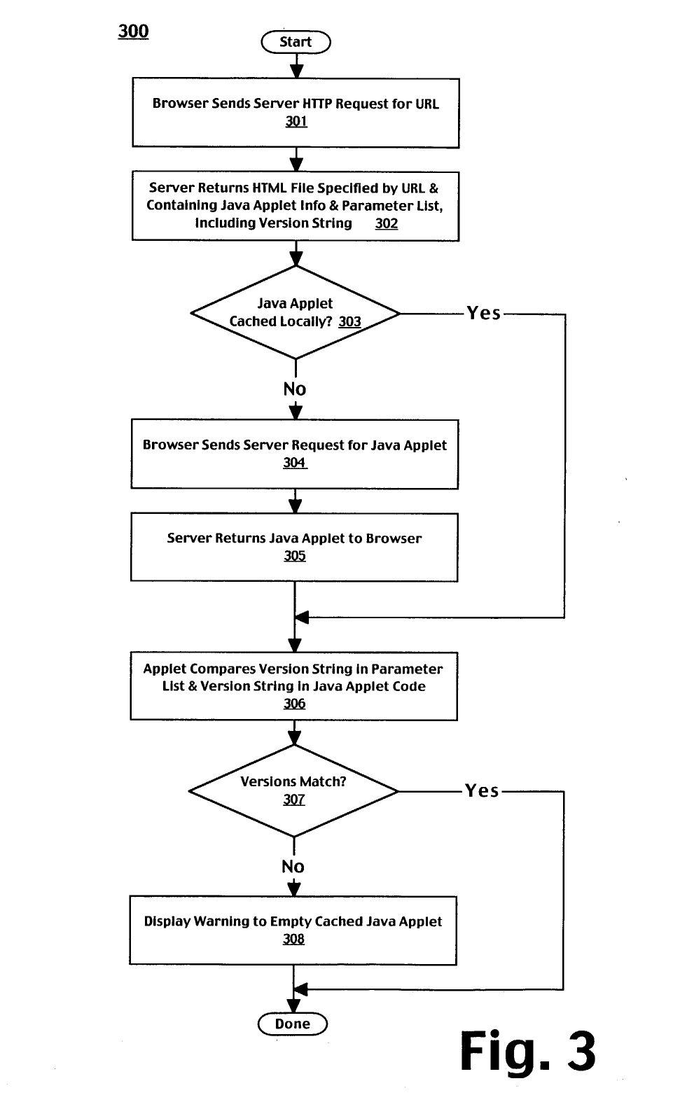

Portions of the detailed descriptions of embodiments of the invention that follow are presented in terms of processes. Although specific steps are disclosed in figures herein (e.g., FIGS. 2, 3) describing the operations of these processes, such steps are exemplary. That is, embodiments of the present invention are well suited to performing various other steps or variations of the steps recited in the flowcharts of the figures herein.

In one embodiment, such processes are carried out by processors and electrical/electronic components under the control of computer readable and computer executable instructions. The computer readable and computer executable instructions reside, for example, in data storage features, memory, registers and other components of a computer system such as a client computer (e.g., client computer 103; FIG. 1). However, the computer readable and computer executable instructions may reside in any type of computer readable medium.

### EXEMPLARY SYSTEM AND METHOD

Embodiments of the present invention are discussed primarily in the context of a system and method for notification of varying versions of code between a server computer and a client computer. With reference to FIG. 1, a network environment 100 upon which an embodiment of the present invention can be deployed is described.

Network environment 100 comprises a client-server system wherein a server computer 101 is coupled through a network 102 to a client computer 103. Network 102 can be a LAN, WAN, the Internet, or any other kind of network. Server computer 101 stores code such as Java applet code and other such code, which is downloaded to client computer 103 via network 102 for execution thereon.

Client computer 103 can run various applications. One such application is applet 105. In one embodiment, applet 105 is a Java applet. Client computer 103 also deploys a web browser 104. Data is transferred by server 101 via network 102 to client computer 103 using an HTTP Protocol upon browser 104 requesting a specified URL from server 101.

Client computer 103 can cache the code of Java applet 105 and other applications downloaded from server 101. When browser 104 makes subsequent requests to the server, Java applet 105 or other code stored in the client computer's cache does not need to be downloaded again.

The version of the code for Java applet 105 stored by server 101 is subject to change, such as for updating. One embodiment of the present invention provides notification to a user of client computer 103 that the version of code cached thereon is at variance with the version stored at server computer 101. By the operation of the present embodiment, the user can be apprised that the code version cached at client computer 103 is not the same version as stored at server 101.

For instance, if the code version stored at server 101 has been updated, the present embodiment notifies the user that the code version cached at client computer 103 is not the same version as the updated version. From this notification, the user can infer that action should be taken to update the version at client computer 103, such as by clearing the cached version to force the updated version to be downloaded from server 101.

FIG. 2 describes a process 200 for notification of varying versions of code between a server computer and a client computer according to one embodiment of the present invention. The operation of the present embodiment, for brevity and clarity, is described by reference to both FIG. 1 and FIG. 2. Process 200 begins with step 201, wherein server 101 returns coded data requested by client computer 103 via network 102.

In step 202, client computer 103 compares the version of code received from server 101 with the version it has cached locally. In one embodiment, this comparison is performed as a function of the application itself, for instance, applet 105. Applet 105 has a comparison module 106 which performs the comparison of step 202.

In step 203, it is determined whether the version of code cached by client computer 103 matches the version of code stored by server 101. If the version of code cached by client computer 103 matches the version of code stored by server 101, process 200 is complete.

If the version of code cached by client computer 103 does not match the version of code stored by server 101, process 200 proceeds to step 204. In step 204, client computer 103 takes an action. In one embodiment, the action taken is to display a message to empty its cache of the code version stored therein. In one embodiment, this message is generated as a function of the application itself, for instance, applet 105. Applet 105 has a messaging module 107 which generates the message displayed in step 204.

In one embodiment, this message can be visual, audible, or both. Visual messages can be pop-up or drop-down windows, email and other textual notifications, colored or shaded flags, and any other visually format. Audible messages can be tones, synthesized voice, and any other audible format.

The message can be a warning to the user of client computer 103 that the code cached therein does not match the current version of the code stored at server 101, and that the cache should be cleared to effectuate downloading the current code version from the server.

In one embodiment, the message generated in step 204 is promulgated by an annunciator 108. Annunciator 108 can be an email application, a display controller, a sound controller, or any other viable messaging mechanism. Upon promulgating the message (and/or taking other action) of step 204, process 200 is complete.

### EXEMPLARY PROCESS APPLIED TO JAVA APPLET CODE

With reference to FIG. 3, a process 300 effectuates notification that varying versions of Java applet code exist between a server computer (e.g., server 101; FIG. 1) and a client computer (e.g., client computer 103; FIG. 1) according to one embodiment of the present invention. It is appreciated that embodiments of the present invention are well suited to code for applications other than applets, and to other than Java code.

Process 300 begins with step 301, wherein a browser (e.g., browser 104; FIG. 1) transmits an HTTP request to the server via a network (e.g., network 102; FIG. 1) for a certain URL.

In step 302, the server returns to the client computer a data file specified by the URL. The data returned to the client computer contains information for a Java applet (e.g., applet 105; FIG. 1), as well as a parameter list, which includes a version string. The version string characterizes the version of Java applet code stored at the sever.

In step 303, it is determined whether the Java applet is cached locally, e.g., at the client computer. If it is determined that the Java applet is cached locally, then process 300 proceeds to step 306 (described below).

However, if it is determined that the Java applet is not cached locally, then process 300 proceeds to step 304, wherein the browser transmits to the server a request for the Java applet.

In step 305, the server returns the Java applet requested to the browser accordingly.

In step 306, the applet compares the version string in the parameter list with the version string in the Java applet code.

In step 307, it is determined whether the version string in the parameter list matches the version string in the Java applet code. If the versions match, process 300 is complete.

However, if the version string in the parameter list does not match the version string in the Java applet code, then process 300 proceeds to step 308. In step 308, the client computer displays a message to empty its cache of the code version stored therein. The message can be a warning, and can take any format as described above. Process 300 is complete at this point.

An embodiment of the present invention, a method for notification of varying versions of code between a server computer and a client computer, is thus described. While the present invention has been described in particular embodiments, the present invention should not be construed as limited by such embodiments, but rather construed according to the following claims and their equivalents.

What is claimed is:

1. A method of notification that a version of code sent by a server computer varies from code cached at a client computer comprising:
receiving said version of code by said client from said server;
comparing said version of code with code cached at said client; and
in response to determining that said version of code differs from said code cached at said client, taking an action.

2. The method as recited in claim 1 wherein said taking an action comprises promulgating a message.

3. The method as recited in claim 2 wherein said message comprises a warning prompting a user of said client to empty said cache of said code cached at said client.

4. The method as recited in claim 1 wherein said code cached at said client comprises a Java applet.

5. The method as recited in claim 4 wherein said comparing comprises contrasting a version string in a parameter list with a version string in said Java applet.

6. The method as recited in claim 4 wherein said taking an action comprises prompting a user of said client to empty a cache of said code cached at said client.

7. A system of notification that a version of code sent by a server computer varies from code cached at a client computer wherein said system is deployed upon said client computer, said system comprising:
a browser for receiving said version of code by said client from said server;
a comparison module coupled to said browser, said comparison module for comparing said version of code with code cached at said client; and
a messaging module coupled to said comparison module, said messaging module for generating a message in response to determining that said version of code differs from said code cached at said client.

8. The system as recited in claim 7 further comprising an annunciator coupled to said warning module, said annunciator promulgating said message to a user of said client computer.

9. The system as recited in claim 8 wherein said message comprises a warning wherein said warning is selected from the group consisting essentially of a visual display, an audible sound, an email, and a window.

10. The system as recited in claim 9 wherein said warning comprises prompting a user of said client to empty said cache of said code cached at said client.

11. The system as recited in claim 7 wherein said code cached at said client comprises a Java applet.

12. The system as recited in claim 11 wherein said comparing comprises contrasting a version string in a parameter list with a version string in said Java applet.

13. The system as recited in claim 11 wherein said generating comprises prompting a user of said client to empty a cache of said code cached at said client.

14. The system as recited in claim 11 wherein said comparison module and said messaging module comprise components of said Java applet.

15. In a client computer system of a client-server network, a computer usable medium having a computer readable program code embodied therein for causing said client computer system to perform a method of notification that a version of code sent by a server computer varies from code cached at a client computer comprising:
receiving said version of code by said client from said server;
comparing said version of code with code cached at said client; and
in response to determining that said version of code differs from said code cached at said client, taking an action.

16. The computer usable medium as recited in claim 15 wherein said taking an action comprises a promulgating a message.

17. The computer usable medium as recited in claim 16 wherein said message comprises a warning prompting a user of said client to empty said cache of said code cached at said client.

18. The computer usable medium as recited in claim 15 wherein said code cached at said client comprises a Java applet.

19. The computer usable medium as recited in claim 18 wherein said comparing comprises contrasting a version string in said parameter list with a version string in said Java applet.

20. The computer usable medium as recited in claim 18 wherein said taking an action comprises prompting a user of said client to empty a cache of said code cached at said client.
